(19) United States
(12) Patent Application Publication
(10) Pub. No.: US 2009/0254712 A1
(43) Pub. Date: Oct. 8, 2009

(54) ADAPTIVE CACHE ORGANIZATION FOR CHIP MULTIPROCESSORS

(76) Inventors: Naveen Cherukuri, San Jose, CA (US); Ioannis Schoinas, Portland, OR (US); Akhilesh Kumar, Sunnyvale, CA (US); Seungjoon Park, Los Altos, CA (US); Ching-Tsun Chou, Palo Alto, CA (US)

Correspondence Address: PRASS LLP, C/O INTELLEVATE, LLC, P.O. BOX 52050, MINNEAPOLIS, MN, 55402, US

(21) Appl. No.: 12/061,027

(22) Filed: Apr. 2, 2008

(51) Int. Cl. G06F 12/00

(52) U.S. Cl. 711/141; 711/E12.001

(57) ABSTRACT

A method, chip multiprocessor tile, and a chip multiprocessor with amorphous caching are disclosed. An initial processing core 404 may retrieve a data block from a data storage. An initial amorphous cache bank 410 adjacent to the initial processing core 404 may store an initial data block copy 422. A home bank directory 424 may register the initial data block copy 422.

### 1. FIELD OF THE INVENTION

The present invention relates generally to the field of chip multiprocessor caching. The present invention further relates specifically to amorphous caches for chip multiprocessors.

### 2. INTRODUCTION

A chip multiprocessor (CMP) system having several processor cores may utilize a tiled architecture, with each tile having a processor core, a private cache (L1), a second private or shared cache (L2), and a directory to track copies of cached private copies. Historically, these tiled architectures may have one of two styles of L2 organization.

Due to constructive data sharing between threads, CMP systems performing multi-threaded workloads may use a shared L2 cache approach. A shared L2 cache approach may maximize effective L2 cache capacity due to no data duplication, but also increases average hit latency, compared to a private L2 cache. These designs may treat the L2 cache and directory as one structure.

CMP systems performing scalar and latency sensitive workloads may prefer a private L2 cache organization for latency optimization at the expense of potential reduction in effective cache capacity due to potential data replication. A private L2 cache may offer cache isolation, yet disallow cache borrowing. Cache intensive applications on some cores may not borrow cache from inactive cores or cores running small data footprint applications.

Some generic CMP systems may have 3-levels of caches. The L1 cache and L2 cache may form two private levels. A third L3 cache may be shared across all cores.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a chip multiprocessor with private and shared caches.

FIG. 2 illustrates in a block diagram one embodiment of a chip multiprocessor with an amorphous cache architecture.

FIG. 3 illustrates in a block diagram one embodiment of a chip multiprocessor tile.

FIG. 4 illustrates in a block diagram one embodiment of a chip multiprocessor with amorphous caches executing data allocation.

FIG. 5 illustrates in a flowchart one embodiment of a method for allocating data block copies in a chip multiprocessor with an amorphous cache.

FIG. 6 illustrates in a block diagram one embodiment of a chip multiprocessor with amorphous caches executing data migration.

FIG. 7 illustrates in a flowchart one embodiment of a method for data replication in a chip multiprocessor with an amorphous cache.

FIG. 8 illustrates in a block diagram one embodiment of a chip multiprocessor with amorphous caches executing copy victimization.

FIG. 9 illustrates in a flowchart one embodiment of a method for data victimization in a chip multiprocessor with an amorphous cache.

FIG. 10 illustrates in a block diagram one embodiment of a chip multiprocessor with a combined amorphous cache bank and directory structure.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and a set of computer instructions, and other embodiments that relate to the basic concepts of the invention. A method, chip multiprocessor tile, and a chip multiprocessor with amorphous caching are disclosed. An initial processing core may retrieve a data block from a data storage. An initial amorphous cache bank adjacent to the initial processing core may store an initial data block copy. A home bank directory may register the initial data block copy.

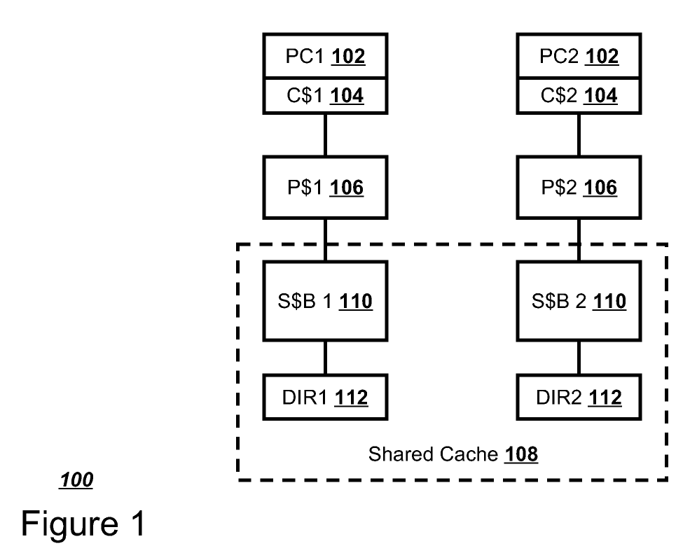

A chip multiprocessor (CMP) may have a number of processors on a single chip each with one or more caches. These caches may be private caches, which store data exclusively for the associated processor, or shared caches, which store data available to all processors. FIG. 1 illustrates in a simplified block diagram one embodiment of a CMP with private and shared caches 100. A CMP 100 may have one more processor cores (PC) 102 on a single chip. A PC 102 may be a processor, a coprocessor, a fixed function controller, or other type of processing core. Each PC 102 may have an attached core cache (C$) 104.

The PC 102 may be connected to a private cache (P$) 106. The P$ 106 may be limited to access by a local PC 102, but may be open to snooping by other PCs 102 based on directory information and protocol actions. A line in the P$ 106 may be allocated for any address by a local PC 102. The PC 102 may access a P$ 106 before handing a request over to a coherency protocol engine to be forwarded on to a directory or other memory sources. A line in the P$ 106 may be replicated in any P$ bank 106.

The PCs 102 may be further connected to a shared cache 108. The shared cache 108 may be accessible to all PCs 102. Any PC 102 may allocate a line in the shared cache 108 for a subset of addresses. The PC 102 may access a shared cache 108 after going through a coherency protocol engine and may involve traversal of other memory sources. The shared cache 108 may have a separate shared cache bank (S$B) 110 for each PC 102. Each data block may have a unique place among all the S$Bs 110. Each S$B 110 may have a directory (DIR) 112 to track the cache data blocks stored in the C$ 104, the P$ 106, the S$B 110, or some combination of the three.

A single cache structure, named here an “amorphous cache”, may act as a private cache, a shared cache, or both at any given time. An amorphous cache may be designed to simultaneously offer the latency benefits of a private cache design and the capacity benefits of a shared cache design. Additionally, the architecture may also allow for run time configuration to add either a private or shared cache bias. A single cache design may act either like a private cache, a shared cache, or a hybrid cache with dynamic allocation between private and shared portions. All PCs 102 may access an amorphous cache. A local PC 102 may allocate a line of the amorphous cache for any address. Other PCs 102 may allocate a line of the amorphous cache for a subset of addresses. The amorphous cache may allow a line to be replicated in any amorphous cache bank based on local PC 102 requests. A local PC 102 may access an amorphous cache bank before going through a coherency protocol engine. Other PCs 102 may access the amorphous cache bank by the coherency protocol engine.

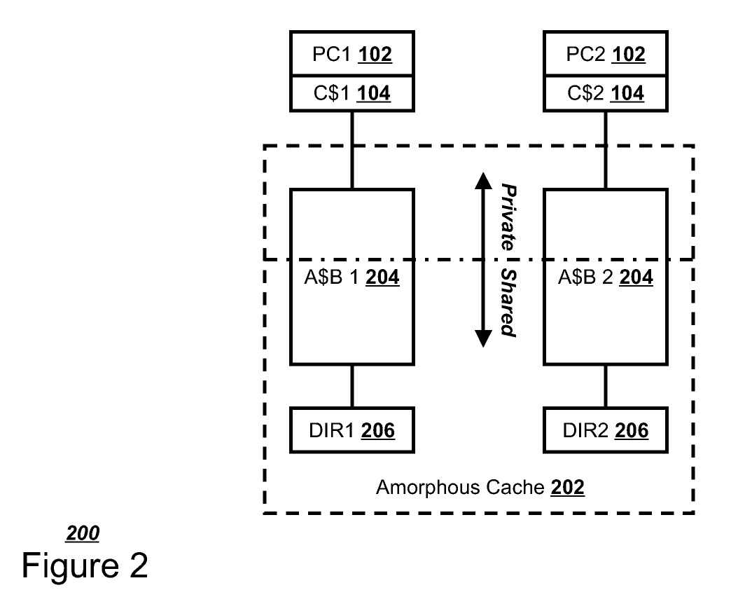

FIG. 2 illustrates in a simplified block diagram one embodiment of a CMP with an amorphous cache architecture 200. One or more PCs 102 with attached C$ 104 may be connected with an amorphous cache 202. The amorphous cache 202 may be divided into a separate amorphous cache banks (A$B) 204 for each PC 102. Each A$B 204 may have a separate directory (DIR) 206 to track the cache data blocks stored in the A$B 204.

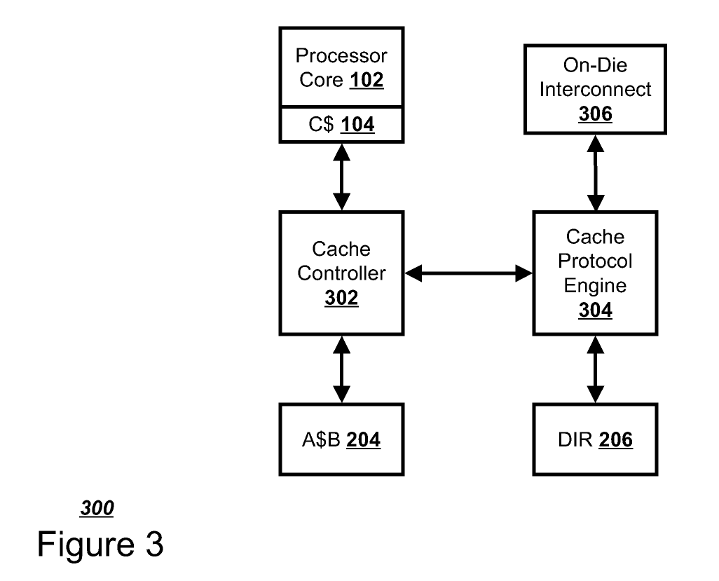

The cache organization may use a tiled architecture, a homogenous architecture, a heterogeneous architecture, or other CMP architecture. The tiles in a tiled architecture may be connected through a coherent switch, a bus, or other connection. FIG. 3 illustrates in a block diagram one embodiment of a CMP tile 300. A CMP tile 300 may have one or more processor cores 102 sharing a C$ 104. The PC 102 may access via a cache controller 302 an A$B 204 that is dynamically partitioned into private and shared portions. The CMP tile 300 may have a DIR component 206 to track all private cache blocks on die. The cache controller 302 may send incoming core requests to the local A$B 204, which holds private data for that tile 300. The cache protocol engine 304 may send a miss in the local A$B to a home tile via an on-die interconnect module 306. The A$ bank at the home tile, accessible via the on-die interconnect module 306, may satisfy a data miss. The cache protocol engine 304 may look up the DIR bank 206 at the home tile to snoop remote private A$Bs, if necessary. A miss at a home tile, after resolving any necessary snoops, may result in the home tile initiating an off-socket request. An A$B 204 configured to act purely as a private cache may skip an A$B 204 home tile lookup but may follow the directory flow. An A$B 204 configured to act purely as a shared cache may skip the local A$B 204 lookup and go directly to the home tile. The dynamic partitioning of an A$B 204 may be realized by caching protocol actions with regards to block allocation, migration, victimization, replication, replacement and back-invalidation.

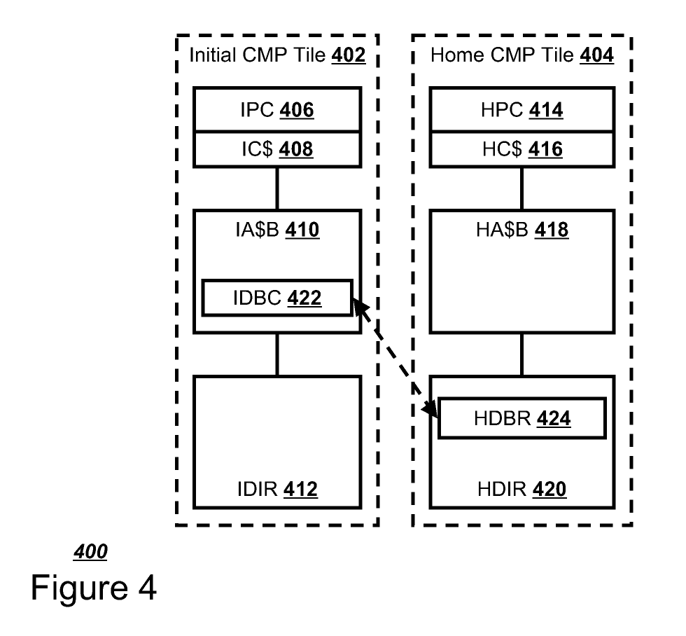

FIG. 4 illustrates in a block diagram one embodiment of a CMP with an amorphous cache 400 executing data allocation. An initial CMP tile 402 may request access to a data block in a data storage unit after checking the home CMP tile 404 for that data block. The initial CMP tile 402 may have an initial processing core (IPC) 406, an initial core cache (IC$) 408, an initial amorphous cache bank (IA$B) 410, and an initial directory (IDIR) 412. The home CMP tile 404 may have a home processing core (HPC) 414, a home core cache (HC$) 416, a home amorphous cache bank (HA$B) 418, and a home directory (HDIR) 420. The initial CMP tile 402 may store an initial data block copy (IDBC) 422, or cache block, in the IA$B 410. The home CMP tile 404 may register a home data block registration (HDBR) 424 in the HDIR 420 to track the copies of the data block in each amorphous cache bank. In previous shared cache architectures, the data block may have been allocated in the home CMP tile 404, regardless of the proximity between the initial CMP tile 402 and the home CMP tile 406.

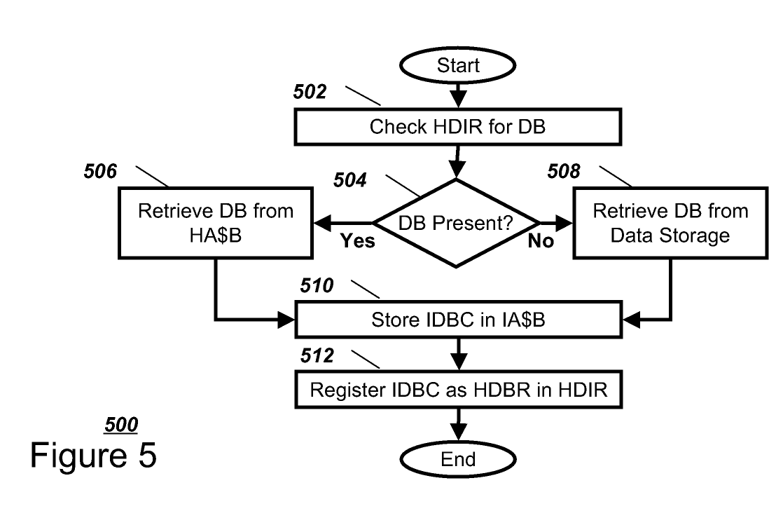

FIG. 5 illustrates in a flowchart one embodiment of a method 500 for allocating data block copies in a CMP 200 with an amorphous cache. The initial CMP tile 402 may check the HDIR for a data block (DB) (Block 502). If the DB is present in the HA$B (Block 504), the initial CMP tile 402 may retrieve the DB from HA$B (Block 506). If the DB is not present in the HA$B (Block 506), the initial CMP tile 402 may retrieve the DB from data storage (Block 508). The initial CMP tile 402 may store an IDBC 422 in the IA$B 410 (Block 510). The home CMP tile 404 may register a HDBR 424 in the HDIR 420 (Block 512).

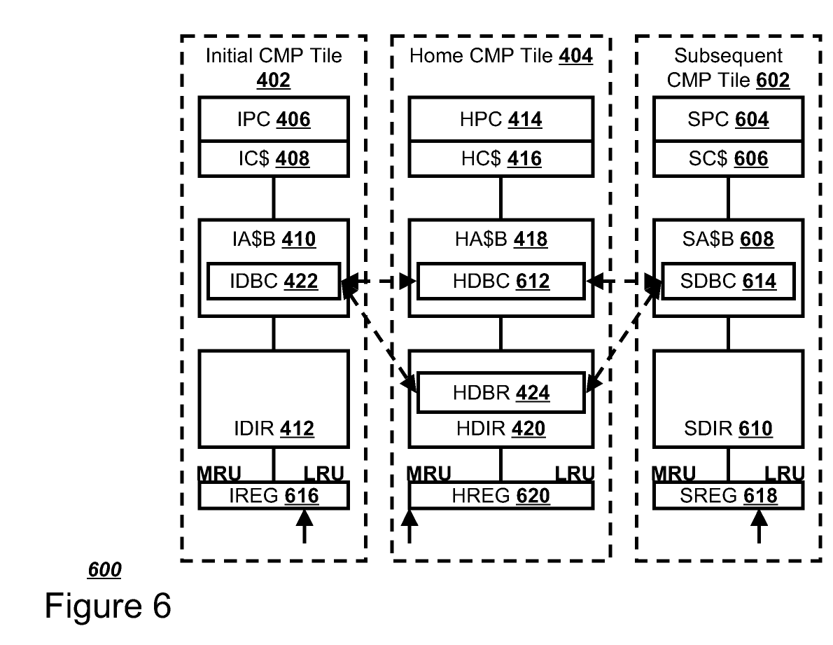

FIG. 6 illustrates in a block diagram one embodiment of a CMP with amorphous caches 600 executing data migration. A subsequent CMP tile 602 may seek the data block stored as an IDBC 422 in the IA$B 410. The subsequent CMP tile 602 may have a subsequent processing core (SPC) 604, a subsequent core cache (SC$) 606, a subsequent amorphous cache bank (SA$B) 608, and a subsequent directory (SDIR) 610. Prior to accessing the data storage to look for the data block, the subsequent CMP tile 602 may check HDIR 420 to determine if a copy of the data block is already present in a cache bank on the chip. If a copy of the data block is present, the home CMP tile 404 may copy the IDBC 422 as a home data block copy (HDBC) 612 to the HA$B 418. The subsequent CMP tile 602 may create a subsequent data block copy (SDBC) 614 in the SA$B 608 from the HDBC 612. Alternately, the subsequent CMP tile 602 may create a subsequent data block copy (SDBC) 614 in the SA$B 608 from the IDBC 422, with the HDBC 612 created afterwards. Later data block copies may be made from the HDBC 612. This migration scheme may provide the capacity benefits of a shared cache. Future requestors may see a reduced latency for this data block over remote private caches. Migration may occur when a second requestor is observed, though migration threshold may be adjusted on a case-by-case basis. Both the initial CMP tile 402 and the subsequent CMP tile 602 may keep a data block copy in the core cache in addition to the amorphous cache, depending on the replication policy in effect.

A shared data block copy may migrate to a HA$B 418 to provide capacity benefits. Each private cache may cache a replica of this shared data block, trading capacity for latency. The amorphous cache may support replication but not require replication. The amorphous cache may replicate opportunistically and bias replicas for replacement compared to individual instances.

The initial CMP tile 402 may have an initial register (IREG) 616 to monitor victimization of the IDBC 422 in the IA$B 410. The IREG 616 may be organized from most recently used (MRU) to least recently used (LRU) cache block, with the LRU cache block being the first to be evicted. Upon copying the IDBC 422 from a data storage or HA$B 418, the IDBC 422 may be entered in the IREG 616 as MRU, biasing the IDBC 422 as being last to be evicted. The home CMP tile 404 may have a home register (HREG) 618 to monitor victimization of the HDBC 612 in the HA$B 418. Upon copying the IDBC 422 from the IA$B 410 to the HA$B 418 to make available to the subsequent CMP tile 602, the HDBC 612 may be entered in the HREG 618 as MRU, biasing the HDBC 612 as being last to be evicted. Further, the IDBC 422 may be moved in the IREG 616 closer to the LRU end, biasing the IDBC 422 towards early eviction. The subsequent CMP tile 602 may have a subsequent register (SREG) 620 to monitor victimization of the SDBC 614 in the SA$B 608. Upon copying the SDBC 614 from the HA$B 418, the SDBC 614 may be entered in the SREG 620 closer to the LRU end, biasing the SDBC 614 towards early eviction.

The IREG 616 may be used to configure the amorphous cache to behave as a private cache or a shared cache, based upon the placement of the IDBC 422 in the IREG 616. For a shared cache setting, the IDBC 422 may be placed in a LRU position in the IREG 616, or remain unallocated. Additionally, the HDBC 612 may be placed in a MRU position in the HREG 620. For a private cache setting, the IDBC 422 may be placed in a MRU position. Additionally, the HDBC 612 may be placed in a LRU position in the HREG 620, or remain unallocated.

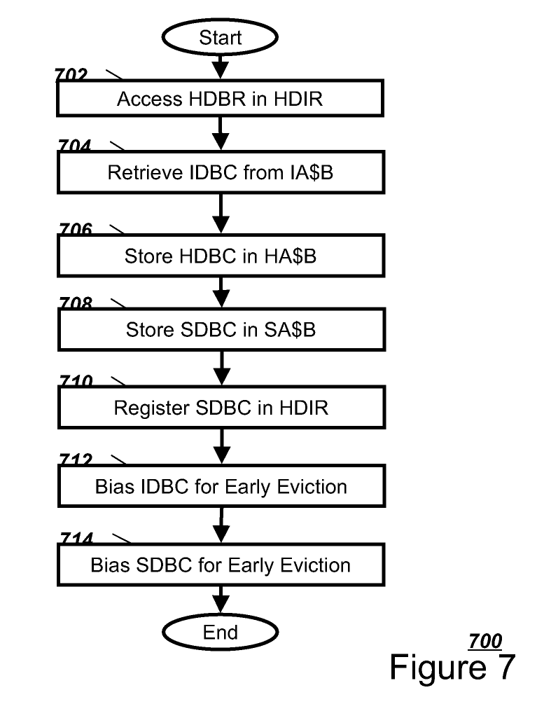

FIG. 7 illustrates in a flowchart one embodiment of a method 700 for data replication in a CMP 200 with an amorphous cache. The subsequent CMP tile 602 may access the HDBR 424 in the HDIR 420 (Block 702). The home CMP tile 404 may retrieve the IDBC 422 from the IA$B 410 (Block 704). The home CMP tile 404 may store the HDBC 612 in the HA$B 418 (Block 706). The subsequent CMP tile 602 may store the SDBC 614 in the SA$B 608 (Block 708). The subsequent CMP tile 602 may register the SDBC 614 in the HDIR 420 (Block 710). The initial CMP tile 402 may bias the IDBC 422 for early eviction (Block 712). The subsequent CMP tile 602 may bias the SDBC 614 for early eviction (Block 714).

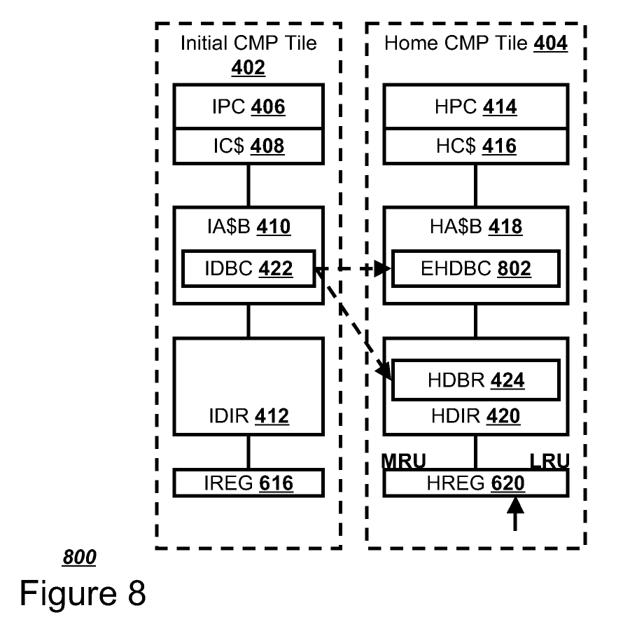

FIG. 8 illustrates in a block diagram one embodiment of a CMP with amorphous caches 800 executing copy victimization. When an exclusive clean or dirty data block copy is evicted from an amorphous cache bank, the initial CMP tile 402 may write the dirty or clean IDBC 422 as an eviction home data block copy (EHDBC) 802 to the HA$B 418. The EHDBC 802 may be entered in the HREG 620 closer to the LRU end, biasing the EHDBC 802 towards early eviction. If a CMP tile with a private cache structure or configuration requests a copy of the EHDBC 802, the EHDBC 802 may remain in a LRU position and the new requestor may place the requestor data block copy in a MRU position. If a later CMP tile makes a request from the home CMP tile 404, the EHDBC 802 may be moved to a MRU position and the later requestor may place the later data block copy in a LRU position.

In previous architectures, a private cache or a shared cache may drop a clean victim, or unaltered cache block, and write back a dirty victim, or altered cache block, to memory. In amorphous caching, writing the IDBC 422 to the HA$B 418 may result in cache borrowing. Cache borrowing may allow data intensive applications to use caches from other tiles.

In previous architectures, the directory victim may require all private cache data block copies to be invalidated, as the private cache data block copies become difficult to track. Future accesses to these data blocks then may require memory access. An amorphous cache may mitigate the impact of invalidation by moving directory victims to the home tile, where tracking by directory is not required.

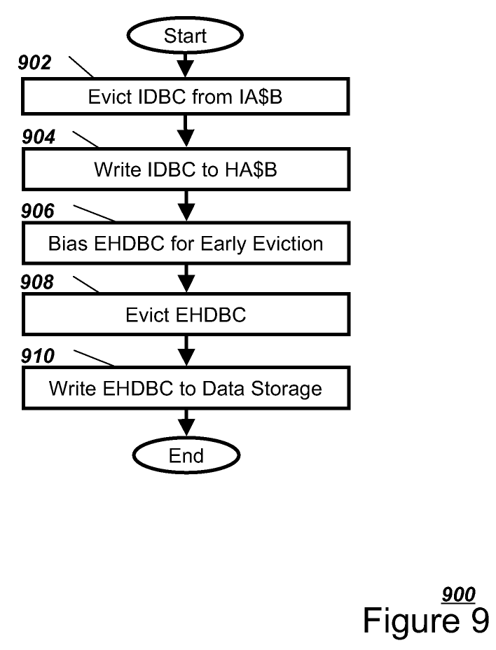

FIG. 9 illustrates in a flowchart one embodiment of a method 700 for data replication in a CMP 200 with an amorphous cache. The initial CMP tile 402 may evict the IDBC 422 from the IA$B 410 (Block 902). The initial CMP tile 402 may write the IDBC 422 to the HA$B 418 (Block 904). The home CMP tile 404 may bias the EHDBC 802 for early eviction (Block 906). When the home CMP tile 404 eventually evicts the EHDBC 802 (Block 908), the home CMP tile 404 may write the EHDBC 802 to data storage (Block 910).

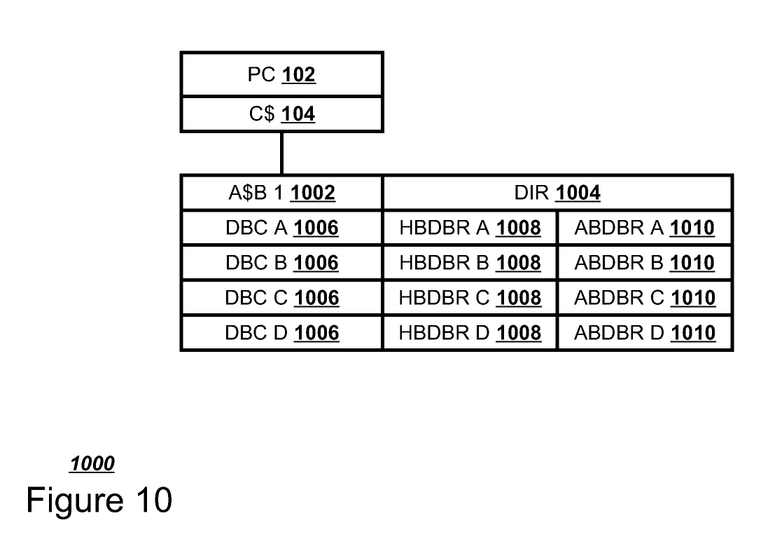

The amorphous cache bank 204 and the directory 206 may be separate constructs. FIG. 10 illustrates in a block diagram one embodiment of a CMP 1000 with a combined amorphous cache bank (A$B) 1002 and directory (DIR) 1004 structure. The A$B 1002 may contain a set of data block copies (DBC) 1006. The DIR 1004 may associate a home bank data block registration (HBDBR) 1008 with the DBC 1006. Further, the DIR 1004 may associate one or more alternate bank data block registration (ABDBR) 1010 with the DBC 1006, resulting in the DIR 1004 having more data blocks than the A$B 1002.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network personal computers, minicomputers, mainframe computers, and the like.

Embodiments may also be practiced in distributed computing environments where tasks are performed by local and remote processing devices that are linked (either by hardwired links, wireless links, or by a combination thereof) through a communications network.

Embodiments within the scope of the present invention may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method, comprising:
retrieving with an initial processing core a data block from a data storage;
storing an initial data block copy in an initial amorphous cache bank adjacent to the initial processing core; and
registering the initial data block copy in a home bank directory.

2. The method of claim 1, further comprising:
retrieving with a subsequent processing core the initial data block copy from the initial amorphous cache bank; and
storing a subsequent data block copy in a subsequent amorphous cache bank adjacent to the subsequent processing core;
registering the subsequent data block copy in the home bank directory.

3. The method of claim 2, further comprising:
storing a home data block copy in a home amorphous cache bank.

4. The method of claim 1, further comprising:
biasing the initial data block copy for earlier eviction from the initial amorphous cache bank.

5. The method of claim 1, further comprising:
evicting the initial data block copy from the initial amorphous cache bank; and
writing the initial data block copy to a home amorphous cache bank.

6. The method of claim 5, further comprising:
biasing the initial data block copy for earlier eviction from the home amorphous cache bank.

7. The method of claim 1, wherein the home bank directory is part of the home amorphous cache bank, and has more blocks available for listing than the home amorphous cache bank has data blocks.

8. An initial chip multiprocessor tile, comprising:
an initial processing core to retrieve a data block from a data storage; and
an initial amorphous cache bank adjacent to the initial processing core to store an initial data block copy registered with a home bank directory.

9. The initial chip multiprocessor tile of claim 8, wherein a subsequent processing core retrieves the initial data block copy from the initial amorphous cache bank and a subsequent amorphous cache bank adjacent to the subsequent processing core stores a subsequent data block copy registered in the home bank directory.

10. The initial chip multiprocessor tile of claim 9, wherein a home amorphous cache bank stores a home data block copy.

11. The initial chip multiprocessor tile of claim 8, wherein the initial data block copy is biased for earlier eviction from the initial amorphous cache bank.

12. The initial chip multiprocessor tile of claim 8, wherein the initial data block copy is evicted from the initial amorphous cache bank and is written to a home amorphous cache bank.

13. The initial chip multiprocessor tile of claim 12, wherein the initial data block copy is biased for earlier eviction from the home amorphous cache bank.

14. A chip multiprocessor, comprising:
an initial processing core to retrieve from a data storage a data block;
an initial amorphous cache bank adjacent to the initial processing core to store an initial data block copy; and
a home bank directory to register the initial data block copy.

15. The chip multiprocessor of claim 14, further comprising:
a subsequent processing core to retrieve the initial data block copy from the initial amorphous cache bank; and
a subsequent amorphous cache bank adjacent to the subsequent processing core to store a subsequent data block copy registered in the home bank directory.

16. The chip multiprocessor of claim 15, further comprising:
a home amorphous cache bank to store a home data block copy.

17. The chip multiprocessor of claim 14, wherein the initial data block copy is biased for earlier eviction from the initial amorphous cache bank.

18. The chip multiprocessor of claim 14, wherein the initial data block copy is evicted from the initial amorphous cache bank and is written to a home amorphous cache bank.

19. The chip multiprocessor of claim 18, wherein the initial data block copy is biased for earlier eviction from the home amorphous cache bank.

20. The chip multiprocessor of claim 14, wherein the home bank directory is part of a home amorphous cache bank, and has more data blocks available for listing than the home amorphous cache bank has data blocks.
